(19) United States
(12) Patent Application Publication
(10) Pub. No.: US 2006/0045395 A1
(43) Pub. Date: Mar. 2, 2006

(54) Shaft member for hydrodynamic bearing device

(76) Inventors: Eiichiro Shimazu, Kuwana (JP); Masaki Egami, Kuwana (JP)

Correspondence Address: ARENT FOX PLLC, 1050 CONNECTICUT AVENUE, N.W., SUITE 400, WASHINGTON, DC, 20036, US

(21) Appl. No.: 11/215,114

(22) Filed: Aug. 31, 2005

(30) Foreign Application Priority Data
Sep. 1, 2004 (JP) 2004-254749

(51) Int. Cl. F16C 32/06

(52) U.S. Cl. 384/100

(57) ABSTRACT

Disclosed is a shaft member for a hydrodynamic bearing device which allows production of a shaft member of smaller size at low cost and which suppresses ion elution from the resin portion, thereby maintaining cleanliness in the hydrodynamic bearing device and making it possible to exert a desired bearing performance. A shaft member 2 is equipped with a shaft portion 2a and a flange portion 2b protruding radially outwards from the shaft portion 2a, and has a composite structure composed of a metal material and a resin composition, in which a resin portion 21 is formed by injection molding of a resin composition containing as a base resin a polyphenylene sulfide (PPS) whose Na content is not more than 2,000 ppm and containing PAN type carbon fibers as a filler.

### BACKGROUND OF THE INVENTION

1. Field of the Invention

The present invention relates to a shaft member for a hydrodynamic bearing device. This shaft member and the hydrodynamic bearing device using the shaft member are suitable for use in a spindle motor of an information apparatus, for example, a magnetic disc apparatus, such as an HDD, an optical disc apparatus, such as a CD-ROM, a CD-R/RW, or a DVD-ROM/RAM, or a magneto-optical disc apparatus, such as an MD or an MO, a polygon scanner motor for a laser beam printer (LBP), a color wheel for a projector, or a small motor for an electric apparatus, such as an axial flow fan.

2. Description of the Related Art

A hydrodynamic bearing is a bearing which rotatably supports a shaft member in a non-contact fashion by a fluid dynamic pressure generated in the bearing clearance. Bearing devices using such a hydrodynamic bearing (hydrodynamic bearing devices) are roughly divided into two types: contact type dynamic bearing devices having a structure in which a radial bearing portion is constructed of a hydrodynamic bearing and in which a thrust bearing portion is constructed of a pivot bearing; and non-contact type dynamic bearing devices having a structure in which both the radial bearing portion and the thrust bearing portion are constructed of hydrodynamic bearings, selection between the two types being appropriately made according to the use thereof.

As an example of a non-contact type dynamic bearing device, there is known one having a structure in which a shaft portion and a flange portion forming the shaft member are integrally formed of a metal material, whereby it is possible to achieve a reduction in the cost of and an improvement in the precision of the shaft member (see, for example, JP 2000-291648 A).

High machining precision and high assembly precision are required of the components of a hydrodynamic bearing device, including the shaft member, in order to secure a high rotation performance as required with the recent increasing improvement of information apparatuses. At the same time, the requirement for a reduction in the cost of a hydrodynamic bearing device is becoming increasingly severe.

### SUMMARY OF THE INVENTION

It is accordingly an object of the present invention to achieve a further improvement in the precision of and a further reduction in the cost of a shaft member of a non-contact type hydrodynamic bearing device.

In order to achieve the above-mentioned object, according to the present invention, a shaft member for a hydrodynamic bearing device includes a shaft portion and a flange portion protruding radially outwards from the shaft portion, and has a composite structure composed of a metal material and a resin composition, in which the resin composition contains as a base resin a polyphenylene sulfide (PPS) whose Na content is not more than 2,000 ppm.

When the shaft member is thus formed of a metal material and a resin composition, there is obtained a structure in which a hydrodynamic bearing device shaft member (hereinafter referred to as the shaft member) entirely formed of a metal material is partially replaced by a resin composition, whereby a reduction in the weight of the shaft member is achieved. Thus, when such a shaft member is used in a hydrodynamic bearing device, the requisite dynamic pressure action of the fluid for supporting the shaft member in a non-contact fashion in the thrust direction may be small. As a result, it is possible to diminish the end surface of the flange portion forming the thrust bearing surface, thereby achieving a reduction in the size of the shaft member. Further, of the shaft member, the resin portion formed by a resin composition can be formed by injection molding, so that, as compared with the case in which the shaft member is processed entirely by machining, it is possible to achieve a reduction in processing cost and an improvement in productivity.

It is desirable for the base resin of the resin composition to be the one superior in mechanical strength, oil resistance, water absorption resistance, heat resistance, etc. Examples of a preferable base resin include: polyphenylene sulfide (PPS), polyetheretherketone (PEEK), polyethersulfone (PES), polyphenylsulfone (PPSF), and polyamideimide (PAI). Above all, taking into account the fluidity in the molten state, polyphenylene sulfide) (PPS) is particularly preferable.

Incidentally, polyphenylene sulfide (PPS) is usually produced through polymerization reaction of paradichlorobenzene (PDCB) and sodium sulfide; in this process, a salt, such as NaCl, is produced as a byproduct, and is mixed with the polyphenylene sulfide (PPS). As a result, when, during the use of the shaft member, Na ions are eluted into the lubricating oil from the resin portion formed by using this resin as the base resin, degeneration of and a change in the viscosity of the lubricating oil will occur, so that there is a fear of the bearing performance being deteriorated. In view of this, in the present invention, a polyphenylene sulfide (PPS) with a Na content of 2,000 ppm or less is selected as the base resin of the resin composition. This helps to reduce the NaCl or the like, which is the byproduct of the polyphenylene sulfide (PPS), and to reduce the amount of Na contained, for example, in the polyphenylene sulfide (PPS). As a result, the amount of Na ions eluted into the lubricating oil is suppressed, and the cleanliness of the interior and the exterior of the bearing are maintained, thereby avoiding deterioration in the bearing performance. To suppress the Na content in the polyphenylene sulfide (PPS) to a level within the above numerical range (2,000 ppm or less), washing is performed by using, for example, a solvent with a large dielectric constant (at least 10 or more). Further, through washing with an acid, it is possible to remove the Na in the molecular terminal group, so that it is possible to further reduce the Na content. Further, of the various polyphenylene sulfides (PPS), a linear type polyphenylene sulfide (PPS) with the least side chains is preferable in that it has a small number of molecular terminal groups per unit volume and a small Na content.

Apart from the above-mentioned requisite characteristics, high strength and impact resistance characteristic are required of the shaft member for a dynamic bearing device with the recent trend to make electronic apparatuses portable. Further, in accordance with down sizing of electronic apparatuses, high dimensional stability is required from the viewpoint of controlling the radial bearing clearance and the thrust bearing clearance with high accuracy. In view of this, in the present invention, carbon fibers as a filler are mixed with the polyphenylene sulfide (PPS) as the base resin. Due to this arrangement, an enhancement in the strength of the shaft member is achieved, and the low thermal dimensional change property of the carbon fibers is made apparent, thus suppressing dimensional changes with temperature changes of the resin portion. As a result, it is possible to control with high accuracy the radial bearing clearance and the thrust bearing clearance in use, thus ensuring the bearing performance. Further, carbon fibers have conductivity; thus, by mixing them with the base resin as a filler, it is possible to endow the shaft member with high conductivity. As a result, it is possible to dissipate the static electricity, with which the rotary member (e.g., the disc hub) side is charged during use, to the grounding side member through the shaft member.

Of the above requisite characteristics, the shaft member is required to exhibit, in particular, high strength, so that it is desirable for the carbon fibers to have a tensile strength of 3000 MPa or more. Further, as an example of carbon fibers endowed with high conductivity as well as high strength, PAN-type (polyacrylonitrile type) carbon fibers may be mentioned.

The reinforcing effect, the dimension stabilizing effect, the static electricity removing effect, etc. can be exerted more conspicuously by taking into account the aspect ratio of the carbon fibers. That is, the larger the fiber length of the carbon fibers, the more enhanced the reinforcing effect and the static electricity removing effect, whereas, the smaller the fiber diameter, the more enhanced the wear resistance and the more it is possible to suppress, in particular, the damage of the associated member on which sliding is effected. From these viewpoints, specifically, it is desirable for the aspect ratio of the carbon fibers to be 6.5 or more.

It is desirable for the filling amount of the carbon fibers as the filler with respect to the base resin to be 10 to 35 vol %. When, for example, the filling amount is less than 10 vol %, the reinforcing effect and the static electricity removing effect due to the filling of the carbon fibers cannot be exerted to a sufficient degree, whereas, when the filling amount exceeds 35 vol %, it is rather difficult to ensure the formability of the shaft member (in particular, the resin portion).

The resin portion can be formed by insert molding (inclusive of outsert molding) using the metal portion formed by the metal material as the insert component; in this process, it is necessary to take into account the melting viscosity of the melting resin (resin composition) injected into the mold. In particular, with the reduction in the size of a recording disk drive device for a hard disk or the like, the dynamic bearing device and the shaft member incorporated into such a drive device is reduced in size. Thus, a low melting viscosity at the time of its supply into the mold (cavity) is required of the resin composition. From these viewpoints, it is desirable for the melting viscosity of the resin composition to be 500 Pa.s or less at a temperature of 310° C. and a shear rate of 1,000 s⁻¹. Here, the temperature of 310° C. corresponds to the temperature of the molten resin in the melting cylinder of the injection molding machine. With this structure, it is possible to fill the region in the cavity corresponding to the resin portion with the molten resin with high accuracy, thus ensuring the formability of the resin portion.

At least the flange portion is included in the resin portion thus formed. Further, it is also possible for the shaft portion to be composed of an external shaft portion having the outer peripheral surface of the shaft portion and an internal shaft portion arranged in the inner periphery of the external shaft portion, with the external shaft portion being formed of a metal material and the internal shaft portion being formed of the resin composition integrally with the flange portion. Alternatively, it is also possible to form the shaft portion solely of a metal material. By thus forming the portion including at least the outer peripheral surface of the shaft portion of a metal material, it is possible to ensure the requisite strength and rigidity of the shaft portion; further, it is possible to ensure the wear resistance of the shaft member against the sliding relative to a metal bearing sleeve arranged on the outer peripheral side of the shaft member.

The above-mentioned shaft member can be provided as a dynamic bearing device equipped with this shaft member, a radial bearing portion rotatably supporting the shaft member in a non-contact fashion in the radial direction by the dynamic pressure action of a fluid, and a thrust bearing portion rotatably supporting the shaft member in a non-contact fashion in the thrust direction by the dynamic pressure action of a fluid. It is desirable for this dynamic bearing device to be provided as a motor having a dynamic bearing device, a rotor magnet, and a stator coil generating a magnetic force between itself and the rotor magnet for use in the above-mentioned information apparatus; in particular, it is suitable for use in a magnetic disk drive device for a hard disk (HDD).

As described above, according to the present invention, it is possible to produce a shaft member of a smaller size at low cost. Further, by suppressing ion elution from the resin portion, the cleanliness of the hydrodynamic bearing device is maintained, whereby it is possible to exert a desired bearing performance in a stable manner for a long period of time.

### BRIEF DESCRIPTION OF THE DRAWINGS

In the accompanying drawings:

FIG. 1 is a sectional view of a shaft member according to an embodiment of the present invention;

FIG. 2a is a plan view (taken in the direction of an arrow a in FIG. 1) of a flange portion;

FIG. 2b is a bottom view (taken in the direction of an arrow b in FIG. 1) of the flange portion;

FIG. 3 is a sectional view of a spindle motor into which a hydrodynamic bearing device equipped with a shaft member is incorporated;

FIG. 4 is a sectional view of a hydrodynamic bearing device;

FIG. 5 is a sectional view of a bearing sleeve;

FIG. 6 is a table showing examples of the carbon fibers used in specimens for comparison test;

FIGS. 7a and 7b are tables showing the compositions of specimens for a comparison test; and

FIGS. 8a and 8b are tables showing evaluation results regarding the requisite shaft member characteristics.

### DETAILED DESCRIPTION OF THE PREFERRED EMBODIMENTS

Hereinbelow, embodiments of the present invention will be described with reference to the drawings.

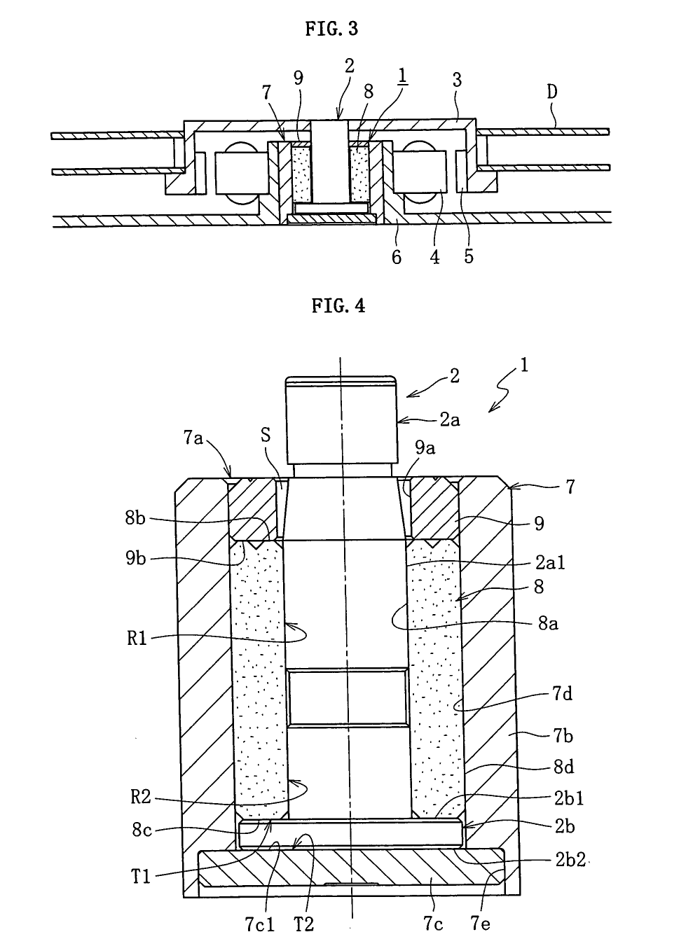

FIG. 3 conceptually shows an example of the construction of a spindle motor for an information apparatus with a hydrodynamic bearing device 1, according to an embodiment of the present invention, incorporated therein. This spindle motor for an information apparatus is used in a disc drive device, such as an HDD, and contains the hydrodynamic bearing device 1 rotatably supporting a shaft member 2 in a non-contact fashion, a disc hub 3 mounted to the shaft member 2, a stator coil 4 and a rotor magnet 5 that are opposed to each other through the intermediation of a radial gap in the radial direction, and a casing 6. The stator coil 4 is mounted to the outer periphery of a casing 6, and the rotor magnet 5 is mounted to the inner periphery of the disc hub 3. The hydrodynamic bearing device 1 has a housing 7 as a component thereof, fixed to the inner periphery of the casing 6. The disc hub 3 retains one or a plurality of disc-like information recording medium D, such as magnetic discs. When the stator coil 4 is energized, the rotor magnet 5 is rotated by a magnetic force generated between the stator coil 4 and the rotor magnet 5, whereby the disc hub 3 and the shaft member 2 rotate integrally.

As shown, for example, in FIG. 4, the hydrodynamic bearing device 1 includes, as main components, the housing 7 having an opening 7a at one end and a bottom portion 7c at the other end, a cylindrical bearing sleeve 8 fixed to an inner peripheral surface 7d of the housing 7, the shaft member 2 composed of a shaft portion 2a and a flange portion 2b, and a seal member 9 fixed to the opening 7a of the housing 7. In the following, for the sake of convenience in illustration, the opening 7a side of the housing 7 will be referred to the upper side, and the bottom portion 7c side of the housing 7 will be referred to as the lower side.

The housing 7 is formed of a soft metal, such as brass, or resin, and is equipped with a cylindrical side portion 7b and the disc-like bottom portion 7c as separate structures. At the lower end of the inner peripheral surface 7d of the housing 7, there is formed a large diameter portion 7e whose diameter is larger than that of the other portion; a cover member constituting the bottom portion 7c is fixed to the large diameter portion 7e by such means as crimping, adhesion, or press-fitting. The side portion 7b and the bottom portion 7c of the housing 7 can also be formed integrally of a metal material or a resin material.

The bearing sleeve 8 is formed in a cylindrical configuration by using, for example, a porous material composed of a sintered metal, in particular, a porous material composed of a sintered metal whose main component is copper. As shown in FIG. 4, on the inner peripheral surface 8a of the bearing sleeve 8, there are provided two upper and lower regions constituting the radial bearing surface of a first radial bearing portion R1 and a second radial bearing portion R2, with the two regions being axially spaced apart from each other.

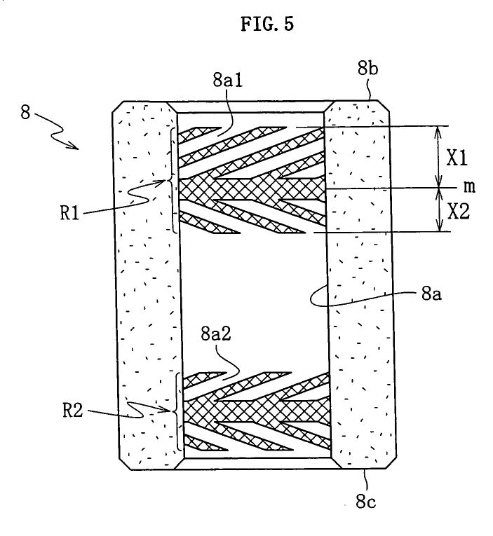

Respectively formed in the above-mentioned two regions are herringbone-shaped dynamic pressure grooves 8a1 and 8a2 as shown, for example, in FIG. 5. The upper dynamic pressure grooves 8a1 are formed axially asymmetrically with respect to the axial center m (the axial center of a region between the upper and lower inclined grooves), with the axial dimension X1 of the region above the axial center m being larger than the axial dimension X2 of the region below the axial center m. The axial length of the upper radial bearing surface (the distance from the upper end to the lower end of the dynamic pressure groove 8a1) is larger than the axial length of the lower radial bearing surface (the distance from the upper end to the lower end of the dynamic pressure grooves 8a2).

As shown in FIG. 4, the seal member 9 as the seal means is annular, and is fixed to the inner peripheral surface of the opening 7a of the housing 7 by means, such as press-fitting or adhesion. In this embodiment, the inner peripheral surface 9a of the seal member 9 is formed in a cylindrical configuration, and the lower end surface 9b of the seal member 9 abuts the upper end surface 8b of the bearing sleeve 8.

A tapered surface is formed on the outer peripheral surface 2a1 of the shaft portion 2a opposed to the inner peripheral surface 9a of the seal member 9, and between this tapered surface and the inner peripheral surface 9a of the seal member 9, there is formed a seal space S, which has a ring shape and whose radial dimension gradually increases from the bottom portion 7c side toward the opening 7a side of the housing 7. Lubricating oil is poured into the inner space of the housing 7 hermetically sealed by the seal member 9, and the interior of the housing 7 is filled with the lubricating oil. In this state, the oil level of the lubricating oil is maintained within the range of the seal space S.

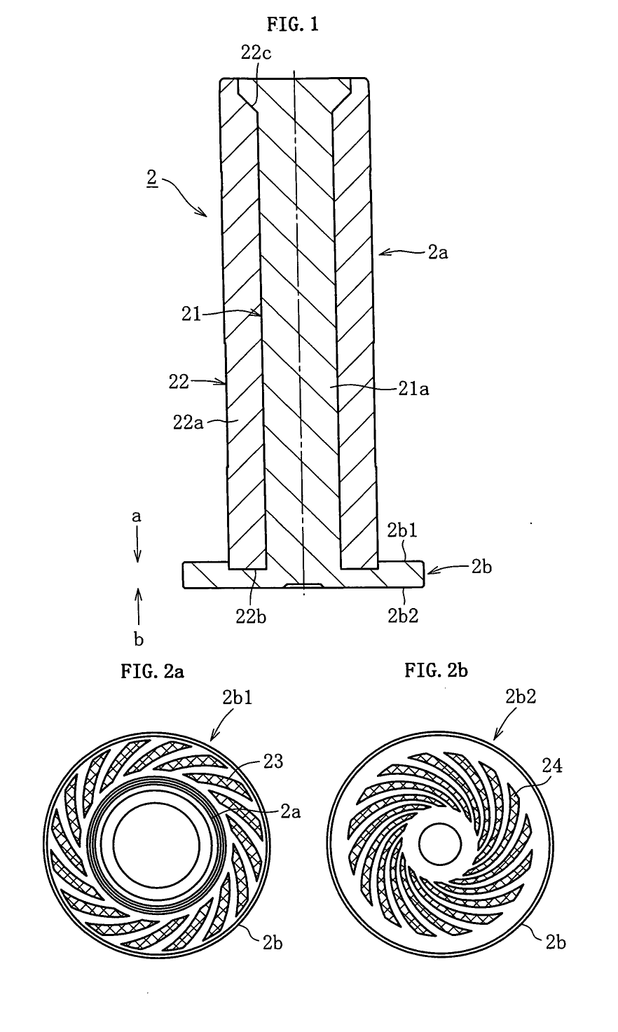

As shown in FIG. 1, the shaft member 2 is equipped with the shaft portion 2a and the flange portion 2b. Further, the shaft member 2 has a composite structure formed of a resin composition and a metal material, and is composed of a resin portion 21 formed of the resin composition and a metal portion 22 formed of the metal material. In this embodiment, the resin portion 21 is composed of an inner shaft portion 21a which extends axially and a flange portion 2b protruding radially outwards from the inner shaft portion 21a, with the two being formed integrally of the resin composition. In this embodiment, the metal portion 22 is an outer shaft portion 22a covering the outer periphery of the resin inner shaft portion 21a, and is formed as a hollow cylinder of a metal material. Thus, the shaft portion 2a has a composite structure, in which the metal outer shaft portion 22a is arranged in the outer periphery and in which the resin inner shaft portion 21a is arranged in the inner periphery.

In order to prevent separation of the metal outer shaft portion 22a, from the resin inner shaft portion 21a and the flange portion 2b, the lower end portion 22b of the outer shaft portion 22a is embedded in the flange portion 2b. At the upper end of the outer shaft portion 22a, the outer shaft portion 22a and the inner shaft portion 21a are axially engaged with each other through the intermediation of an engagement portion formed of the inner shaft portion 21a and a tapered surface 22c or the like. Although not shown, a knurled engagement portion capable of being circumferentially engaged with the flange portion 2b may be formed by knurling or the like in the outer periphery or at the edge of the outer shaft portion 22a embedded in the flange portion 2b.

For the metal portion 22 forming the outer shaft portion 22a, there is used a metal material, such as stainless steel, taking into account, strength, wear resistance, and corrosion resistance. For the resin portion 21 forming the inner shaft portion 21a and the flange portion 2b, it is possible to use, as the base resin, polyphenylene sulfide (PPS), polyetheretherketone (PEEK), polyethersulfone (PES), polyphenylsulfone (PPSF), polyamideimide (PAI), etc., taking into account oil resistance, water absorption resistance, heat resistance, etc.

Above all, from the viewpoint, in particular, of cost and fluidity (viscosity) during molding, polyphenylene sulfide (PPS) is preferable. Incidentally, polyphenylene sulfide (PPS), which is generally produced through condensation polymerization reaction of sodium sulfide and paradichlorobenzene, includes sodium chloride as a byproduct at the same time. Thus, by using, for example, an appropriate solvent, the polyphenylene sulfide (PPS) is washed. It is only necessary for the solvent for washing the polyphenylene sulfide (PPS) to be the one having a dielectric constant of at least 10 or more, more preferably, 20 or more, and most preferably, 50 or more. Further, also taking the environmental factor into account, it is desirable to use, for example, water (dielectric constant: 80), in particular, ultra pure water. By effecting washing with such a solvent, it is possible to reduce the Na content of the polyphenylene sulfide (PPS), making it possible to use it as the resin material for forming the resin portion 21 of the shaft member 2. A standard Na content suitably usable for the above resin material is 2,000 ppm or less, more preferably, 1,000 ppm or less, and most preferably, 500 ppm or less. Further, by washing the polyphenylene sulfide (PPS) with an acid, mainly the Na of the terminal group of the polyphenylene sulfide (PPS) is removed, so that a further reduction in the Na content is possible. Further, by removing the Na of the molecular terminal group, it is advantageously possible to expedite the crystallization of the polyphenylene sulfide (PPS).

Polyphenylene sulfide (PPS) can be roughly classified into: cross-linking polyphenylene sulfide (PPS), semi-linear type polyphenylene sulfide (PPS) with few side chains, and straight-chain type (linear type) polyphenylene sulfide (PPS) with still fewer side chains. Of these, linear type polyphenylene sulfide (PPS), which has the least side chains, is more preferable in that it has a small number of molecular terminal groups per unit volume and a small Na content. Further, as compared with other types of polyphenylene sulfide (PPS), linear type polyphenylene sulfide (PPS) is preferable in that it is easy to wash or that it easily allows a reduction in Na content through washing. Regarding the Na content, the one with an Na content of 2,000 ppm or less, more preferably, the one with an Na content of 1,000 ppm or less, and most preferably, the one with an Na content of 500 ppm or less corresponds to the above-mentioned linear type polyphenylene sulfide (PPS). By using this type of polyphenylene sulfide (PPS), it is possible to suppress the amount of Na ions eluted into the lubricating oil, so that it is possible to prevent deposition of Na ions on the hydrodynamic bearing device 1, the disc-like information recording medium D retained by the disc hub 3, or the surface of the disc head (not shown)

Carbon fibers can be mixed with the above-mentioned base resin as a filler. This makes it possible to enhance the strength of the shaft member 2, and to suppress dimensional changes as a result of changes in the temperature of the shaft member 2 to thereby obtain high dimensional stability. As a result, it is possible to control with high accuracy the radial bearing clearance and the thrust bearing clearance during use, thus making it possible to ensure the requisite bearing performance. Further, by mixing carbon fibers with the base resin, the high conductivity of the carbon fibers is exerted, making it possible to endow the resin portion 21 with sufficient conductivity (e.g., 10⁷ Ω-cm or less in terms of volume resistance). As a result, it is possible to dissipate the static electricity with which the rotary member (e.g., the disc-like information recording medium D) side is charged during use to the grounding side member (casing 6, etc.) through the shaft member 2.

While various types of carbon fibers such as PAN type or Pich type can be used, from the viewpoint of reinforcing effect (requisite tensile strength for the molding is 120 MPa) and impact absorbing property, carbon fibers with relatively high tensile strengths (preferably 3000 MPa or more) are preferable; in particular, as carbon fibers also having high conductivities, PAN type carbon fibers are preferable. Further, in order to sufficiently exert the reinforcing effect, dimension stabilizing effect, static electricity removing effect, etc. due to the mixing of the carbon fibers with the base resin (PPS), it is desirable for the aspect ratio of the carbon fibers to be 6.5 or more. The smaller the fiber diameter, the preferable it is as long as the operability is not impaired; also taking into account the availability, a fiber diameter ranging from 3 to 10 μm is preferable. As shown by comparison of various resin examples in which the amount of carbon fibers mixed is the same, with the fiber diameter varying, a resin containing carbon fibers with small fiber diameter contains a larger number of fibers, so that it easily provides a uniform molding. Further, to exert the high strength of carbon fibers to a sufficient degree, it is desirable to use carbon fibers with a fiber length of 100 μm or more. In particular, taking into consideration the fact that when performing melt-kneading for recycling, the carbon fibers are broken and shortened, a fiber length of 1 mm or more is more preferable.

To exert the reinforcing effect, static electricity removing effect, etc. due to the above-mentioned carbon fibers to a sufficient degree, it is desirable for the filling amount of carbon fibers with respect to the base resin to be 10 to 35 vol %, more preferably, 15 to 25 vol %. When the filling amount of carbon fibers is less than 10 vol %, the reinforcing effect, static electricity removing effect, etc. due to the carbon fibers cannot be exerted to a sufficient degree; further, the requisite wear resistance of the portion of the shaft member 2 sliding on another component is not ensured, whereas, when the filling amount exceeds 35 vol %, the formability of the shaft member 2, in particular, the resin portion 21, deteriorates, making it impossible to obtain high dimensional accuracy (While it depends on the bearing size, the thickness dimension tolerance of the flange portion 2a, for example, is 0.7±0.0015 mm).

Since the cavity is filled with molten resin with high accuracy, it is desirable for the melting viscosity of the resin composition consisting of a base resin mixed with a filler, such as carbon fibers, to be suppressed to a level of not more than 500 Pa.s at a temperature of 310° C. and a shear rate of 1,000 s⁻¹. Thus, also from the viewpoint of compensating for the reduction in viscosity due to the filling with the filler, it is desirable for the melting viscosity of the base resin to be not more than 100 Pa.s at a temperature of 310° C. and a shear rate of 1,000 s⁻¹.

In this way, when a polyphenylene sulfide (PPS) with an Na content of 2,000 ppm or less is used as the base resin of the resin portion 21, it is possible to form a shaft member 2 endowed with high oil resistance, low ion elution property, low water absorption property, and high heat resistance, so that it is possible to maintain a high level of cleanliness for the hydrodynamic bearing device 1 and the disk drive device in which the hydrodynamic bearing device 1 is incorporated. Further, by injecting a resin composition mixed with an appropriate amount of carbon fibers of PAN type, etc. into a mold, using, for example the metal portion 22, as an insert component, to thereby form the resin portion 21, it is possible to obtain a shaft member 2 superior in strength, dimensional stability, static electricity removing property, and formability.

While the shaft member 2 as completed can be used regardless of its size, a shaft member 2 whose shaft portion 2a has a diameter of, for example, 6 mm or less, and whose axial length (entire axial length) is not more than 20 mm can be suitably used for a magnetic disk drive device, such as a hard disk drive (HDD), in a state in which the shaft member 2 is incorporated into the hydrodynamic bearing device 1.

The end surfaces 2b1 and 2b2 of the flange portion 2b have dynamic pressure regions constituting thrust bearing surfaces for generating dynamic pressure. As shown, for example, in FIGS. 2a and 2b, a plurality of spiral dynamic pressure grooves 23 and 24 are formed in the thrust bearing surfaces, and these dynamic pressure regions are mold-shaped simultaneously with the insert molding of the flange portion.

The shaft portion 2a of the shaft member 2 is inserted into the inner periphery of the bearing sleeve 8, and the flange portion 2b is accommodated between the lower end surface 8c of the bearing sleeve 8 and the inner bottom surface 7c1 of the housing 7. The two upper and lower radial bearing surfaces of the inner peripheral surface 8a of the bearing sleeve 8 are opposed to the outer peripheral surface 2a1 of the shaft portion 2a (the outer peripheral surface of the outer shaft portion 22a) through the intermediation of the radial bearing clearance, thus forming the radial bearing portion R1 and the radial bearing portion R2. The thrust bearing surface formed on the upper end surface 2b1 of the flange portion 2b is opposed to the lower end surface 8c of the bearing sleeve 8 through the intermediation of the thrust bearing clearance, thus forming the thrust bearing portion T1. Further, the thrust bearing surface formed on the lower end surface 2b2 of the flange portion 2b is opposed to the inner bottom surface 7c1 of the bottom portion 7c of the housing 7 through the intermediation of the thrust bearing clearance, whereby the thrust bearing portion T2 is formed.

Due to the above-described construction, during rotation of the shaft member 2, a dynamic pressure of the lubricating oil is generated in the radial bearing clearances of the radial bearing portions R1 and R2 by the action of the dynamic pressure grooves 8a1 and 8a2 as described above, and the shaft portion 2a of the shaft member 2 is rotatably supported in the radial direction in a non-contact fashion by films of lubricating oil formed in the radial bearing clearances. At the same time, by the action of the dynamic pressure grooves formed in the end surfaces 2b1 and 2b2 of the flange portion 2b, a dynamic pressure of the lubricating oil is generated in the thrust bearing clearances of the thrust bearing portions T1 and T2 and the flange portion 2b of the shaft member 2 is rotatably supported in both thrust directions in a non-contact fashion by films of lubricating oil formed in the thrust bearing clearances.

An embodiment of the present invention is described above, but the above-described embodiment of the present invention should not be construed restrictively.

The present invention is applicable to all hydrodynamic bearing devices of the type which are equipped with a shaft member 2 having a shaft portion 2a and a flange portion 2b. That is, while in the above-described embodiment the shaft portion 2a is formed by the metal outer shaft portion 22a and the resin inner shaft portion 21a, this should not be construed restrictively; it is also possible to form the entire shaft portion 2a of a metal material. Further, while in the above-described embodiment the dynamic pressure grooves 23 and 24 are formed in both end surfaces 2b1 and 2b2 of the flange portion, it is also possible to form the dynamic pressure grooves in the surfaces opposed to the end surfaces 2b1 and 2b2 (for example, the lower end surface 8c of the bearing sleeve 8 and the inner bottom surface 7c1 of the bottom portion 7c of the housing 7). Further, the thrust bearing portion T2, which is formed in the lower portion in the above-described embodiment, may also be formed in some other portion, for example, between the end surface of the opening 7a of the housing 7 and the end surface of the rotary member opposed thereto (the disc hub 3, etc.).

While in the above-described embodiment carbon fibers are mixed with one kind of base resin (PPS), it is also possible to add some other thermoplastic resin or thermosetting resin, or an organic substance, such as a rubber component, as long as the effect of the present invention is not impaired; further, in addition to the carbon fibers, it is also possible to add an inorganic substance, such as metal fibers, glass fibers, or whiskers. For example, it is possible to add polytetrafluoroethylene (PTFE) as a releasing agent, and carbon black as a conductivity imparting agent.

### EXAMPLES

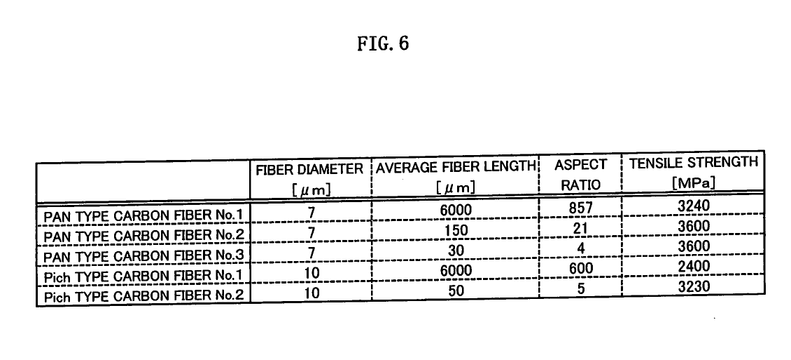

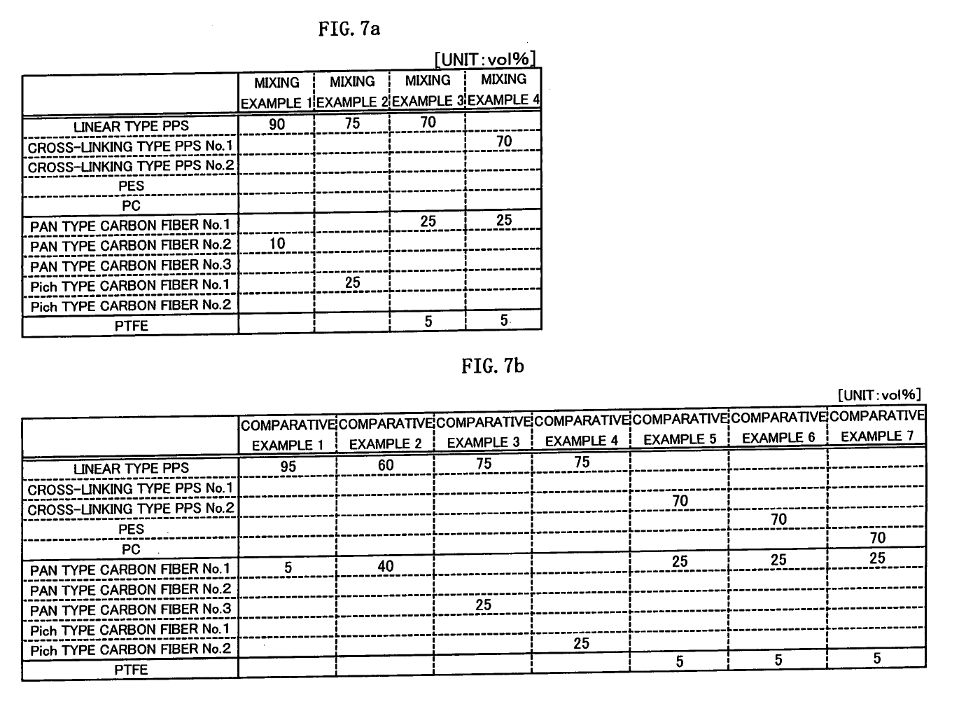

To clarify the usefulness of the present invention, a plurality of resin compositions of different compositions were evaluated in terms of the requisite characteristics of the shaft member 2. As the base resin, one of three different kinds of polyphenylene sulfide (PPS) (one kind of linear type resin and two kinds of cross-linking type resins) was used. As the filler to be mixed with the base resin, one of five kinds of carbon fibers (three kinds of PAN type fibers and two kinds of Pich type fibers) differing in fiber diameter and fiber length (differing in aspect ratios), as shown in FIG. 6, was used. FIGS. 7a and 7B show examples of a combination and mixing ratio of these base resins and fillers (carbon fibers).

In these examples: as the linear type polyphenylene sulfide (PPS), LC-5G manufactured by DAINIPPON INK AND CHEMICALS, INC. was used; as the two kinds of cross-linking polyphenylene sulfide (cross-linking PPSs No. 1 and No. 2), there were used T-4 manufactured by DAINIPPON INK AND CHEMICALS, INC. and MB-600 manufactured by DAINIPPON INK AND CHEMICALS, INC., respectively; as the polyether sulfone (PES), 4100G manufactured by Sumitomo Chemical Co., Ltd. was used; and as the polycarbonate (PC), S-2,000 manufactured by Mitsubishi Engineering-Plastics Corp. was used. As the three kinds of PAN type carbon fibers (No. 1, No. 2, and No. 3), there were used HM35-C6S manufactured by Toho Tenax Co., Ltd. MLD-1000 manufactured by Toray Industries, Inc., and MLD-30 manufactured by Toray Industries, Inc., respectively, and as the two kinds of Pich type carbon fibers (No. 1 and No. 2), there are used K223NM manufactured by Mitsubishi Chemical Corporation, and K223QM manufactured by Mitsubishi Chemical Corporation, respectively. Further, in these examples, polytetrafluoroethylene (PTFE) was used as the releasing agent; more specifically, KT-620 manufactured by Kitamura Co., Ltd. was used.

The items of evaluation for the specimens are: (1) Na content [ppm], (2) Na ion elution amount [μg/cm²], (3) volume resistance [Ω.cm], (4) tensile strength [MPa], (5) wear depth of the specimen [μm], (6) wear depth of the associated member on which sliding occurs [μm], and (7) insert formability. The evaluation methods for the above items (the methods of measuring the evaluation item values) are as follows.

(1) Na Content [ppm]

The specimen (resin bulk body) was incinerated by the sulfuric acid incineration method, and was then dissolved in diluted hydrochloric acid to measure the Na ion concentration by an atomic absorption spectro photometer. The specific procedures are as follows: <1>0.10 g of the specimen is weighed accurately, and 0.3 g of undiluted sulfuric acid is collected in a platinum plate. <2>In a drafter, the specimen is heated and carbonized on an electric heating ceramic plate, and a muffle is placed thereon to heat until no smoke comes out. <3>The platinum plate is transferred to a muffle electric furnace of 700° C. (high temperature furnate), and is further heated for 40 minutes to completely incinerate the specimen. <4>After incineration, 10 cc of 1.2 N hydrochloric acid is added to the cooled specimen to dissolve the ash content. <5>This is transferred into a polyethylene measuring flask and dissolved by adding ion exchange water (to obtain a prepared solution). <6>A secondary standard solution in which an Na standard solution was diluted to a predetermined amount, and, based on this prepared standard solution, the Na ion concentration coefficient is obtained by an atomic absorption spectro photometer (including a data processing device). <7>The Na ion content concentration of the specimen was measured by using the atomic absorption spectro photometer based on the prepared solution prepared in procedure <5>. <8>Measurement is performed three times with different specimens to obtain the average value.

(2) Na Ion Elution Amount [μg/cm²]

The Na ion elution amount of the specimen (shaft member) after insert molding was measured by ion chromatography. The specific procedures are as follows. <1>A predetermined amount of ultrapure water is put in an empty beaker, and a specimen whose surface area has been calculated previously is put in it. <2>The beaker is set in an ultrasonic washing machine for a predetermined time to cause the ions contained in the surface and interior of the specimen to be eluted into the ultrapure water. Apart from this, a beaker containing solely pure water and in which no specimen is put is also set in the ultrasonic washing machine to prepare a blank. It is desirable for the ultrasonic washing machine used here to be of a frequency ranging from 30 to 50 kHz and of an output of approximately 100 to 150 W. <3>The Na ion amount contained in the ultrapure water in which the specimen is put, prepared as described above, is measured by ion chromatography (measurement value A). Apart from this, the Na ion amount contained in the blank is also measured in a similar fashion (measurement value B). <4>The value obtained by subtracting measurement value B from measurement value A is regarded as the Na ion concentration per 1 ml of the ultrapure water containing the specimen, and this value is multiplied by the ultrapure water amount used in the ion elution and is divided by the sample surface area to obtain the Na ion elution amount per unit surface area [μg/cm²]. A sample whose Na content is not more than 2,000 ppm and whose Na ion elution amount is less than 0.01 μg/cm² is indicated by symbol O.

(3) Volume Resistance [Ω.cm]

Measurement was performed by the four-point probe method according to JIS 7194. A specimen whose volume resistance is less than 10⁷ Ω.cm is indicated by symbol O.

(4) Tensile Strength [MPa]

Measurement was performed by JIS K7113 (dumb-bell No. 1). A specimen whose tensile strength is not less than 120 MPa is indicated by symbol O.

(5) Wear Depth of the Specimen [μm] and

(6) Wear Depth of the Associated Member on Which Sliding is Effected [μm]

Measurement was performed by a ring-on-disc test, in which a ring-like specimen is pressed against a disc-like associated sliding member with a predetermined load in lubricating oil and, in this state, the specimen side is rotated. More specifically, a ring-like resin molding of Ø21 mm (outer diameter)×Ø17 mm (inner diameter)×3 mm (thickness) was used as the specimen. Further, as the associated sliding member, A5056 disc member with a surface roughness of Ra 0.04 μm and with a size of Ø30 mm (diameter)×5 mm (thickness) was used. The lubricating oil used was di (2-ethylhexyl) azelate as a diester oil. The kinematic viscosity of this lubricating oil at 40° C. is 10.7 mm²/s. During the ring-on-disc test, the surface pressure of the associated sliding member with respect to the specimen was 0.25 MPa, the rotating speed (peripheral speed) was 1.4 m/min., the test time was 14 hours, and the oil temperature was 80° C. A specimen in which the wear depth of the ring-like specimen and that of the associated sliding member are both not more than 4 μm and in which the sum total of the wear depths of the specimen and the associated member is not more than 5 μm is indicated by symbol O.

(7) Insert Moldability

Insert molding of the specimen was performed using the metal portion 22 of the configuration as shown in FIG. 1 as the insert component, evaluating the specimen as to modability and the shrinkage amount (indicated by symbol O when it is 2 μm or less) due to contraction at the time of solidification of the flange portion.

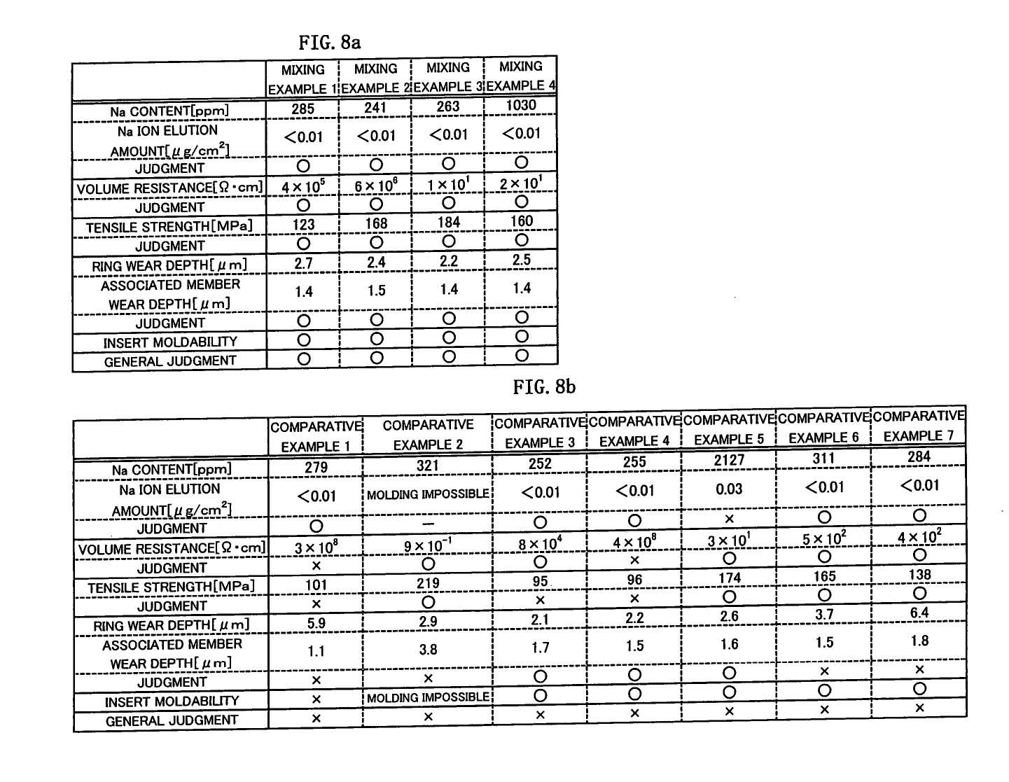

FIG. 8a and 8b show the evaluation results of the specimens regarding the evaluation items (1) through (7). In a specimen in which, as in Comparative Example 5, a cross-linking polyphenylene sulfide (PPS) is used as the base resin, there were detected eluted Na ions in an amount to a degree not negligible in terms of the adverse effect on the lubricating oil, etc. When, as in Comparative Examples 3 and 4, the aspect ratio of the carbon fibers contained in the specimen is small (<6.5), a sufficient reinforcing effect cannot be obtained. When, as in Comparative Example 1, the mixing ratio of the carbon fibers is small (<10 vol %), not only is the volume resistance of the specimen insufficient, but also it is impossible to ensure the requisite wear resistance characteristic for the specimen. When, as in Comparative Example 2, the mixing ratio of the carbon fibers is large (>35 vol %), it is impossible to avoid wear of the associated sliding member while it is possible to suppress wear of the specimen. In contrast, in Mixing Examples 1 through 4 of the present invention, it was possible to obtain results superior to Comparative Examples in all respects, such as cleanliness (Na ion elution amount), static electricity removing property (volume resistance), strength (tensile strength), and wear resistance characteristic (wear depth of the specimen and the associated member).

What is claimed is:

1. A shaft member for a hydrodynamic bearing device comprising a shaft portion, and a flange portion protruding radially outwards from the shaft portion, the shaft member having a composite structure composed of a metal material and a resin composition,
wherein the resin composition contains as a base resin a polyphenylene sulfide (PPS) whose Na content is not more than 2,000 ppm.

2. A shaft member for a hydrodynamic bearing device according to claim 1, wherein the polyphenylene sulfide (PPS) is a linear type polyphenylene sulfide.

3. A shaft member for a hydrodynamic bearing device according to claim 1, wherein the resin composition contains carbon fibers.

4. A shaft member for a hydrodynamic bearing device according to claim 3, wherein the carbon fibers have a tensile strength of 3000 MPa or more.

5. A shaft member for a hydrodynamic bearing device according to claim 3, wherein the carbon fibers are PAN type carbon fibers.

6. A shaft member for a hydrodynamic bearing device according to claims 3, wherein the carbon fibers have an aspect ratio of 6.5 or more.

7. A shaft member for a hydrodynamic bearing device according to claims 3, wherein the carbon fibers are contained in the resin composition in an amount of 10 to 35 vol %.

8. A shaft member for a hydrodynamic bearing device according to claim 1, wherein at least the flange portion is formed of the resin composition.

9. A shaft member for a hydrodynamic bearing device according to claim 1, wherein the shaft portion comprises an outer shaft portion formed of a metal material, and an inner shaft portion arranged in an inner periphery of the outer shaft portion and formed integrally with the flange portion of the resin composition.

10. A hydrodynamic bearing device comprising: the shaft member for a hydrodynamic bearing device according to any one of claims 1 through 9; a radial bearing portion supporting the shaft member for a hydrodynamic bearing device in a radial direction in a non-contact fashion by a dynamic pressure action of a fluid; and a thrust bearing portion supporting the shaft member for a hydrodynamic bearing device in a thrust direction in a non-contact fashion by a dynamic pressure action of a fluid.

11. A motor comprising: the hydrodynamic bearing device according to claim 10; a rotor magnet; and a stator coil generating a magnetic force between the stator coil and the rotor magnet.
